(19) United States
(12) Patent Application Publication
(10) Pub. No.: US 2016/0235014 A1
(43) Pub. Date: Aug. 18, 2016

(54) LIGHT DISTRIBUTION SYSTEM

(71) Applicant: BioVantage International, Inc., Colorado Springs, CO (US)

(72) Inventors: Matthew Edward Donham, Colorado Springs, CO (US); Gary C. Bjorklund, Pacific Grove, CA (US)

(21) Appl. No.: 15/045,715

(22) Filed: Feb. 17, 2016

Related U.S. Application Data
(60) Provisional application No. 62/117,092, filed on Feb. 17, 2015.

(51) Int. Cl. A01G 7/04; F21V 23/00; A01G 1/00; F21V 8/00

(52) U.S. Cl. CPC A01G 7/045; G02B 6/0006; G02B 6/0096; F21V 23/003; A01G 1/001; F21Y 2113/005

(57) ABSTRACT

In accordance with one embodiment, a method of growing one or more plants can be implemented wherein the one or more plants establish a canopy that shades an intra-canopy volume of the one or more plants from direct illumination. The method can include coupling a light source with a light distribution device; disposing the light distribution device in a position to directly illuminate the canopy region of the one or more plants and to directly illuminate the intra-canopy volume of the one or more plants.

### CROSS-REFERENCE TO RELATED APPLICATIONS

This application claims the benefit under 35 U.S.C. §119(e) of U.S. provisional patent application 62/117,092 filed on Feb. 17, 2015 and titled “Light Distribution System” which is hereby incorporated by reference in its entirety and for all purposes.

### SUMMARY

In accordance with one embodiment, a method of growing one or more plants can be implemented wherein the one or more plants establish a canopy that shades an intra-canopy volume of the one or more plants from direct illumination. The method can include coupling a light source with a light distribution device; disposing the light distribution device in a position to directly illuminate the canopy region of the one or more plants and to directly illuminate the intra-canopy volume of the one or more plants.

In accordance with another embodiment, a method can be implemented that includes providing a first light source capable of producing light of at least a first wavelength; providing a second light source capable of producing light of at least a second wavelength, wherein the second wavelength is different from the first wavelength; coupling the first light source and the second light source to a light distribution device; illuminating a canopy region and an intra-canopy volume with light produced from the first light source for a first period of time; and, illuminating the canopy region and the intra-canopy volume with light produced from the second light source for a second period of time.

In still another embodiment, a system can be implemented for growing one or more plants wherein the one or more plants establish a canopy that shades an intra-canopy volume of the one or more plants from direct illumination. The system can include a light distribution device; a light source coupled with the light distribution device; wherein the light distribution device is positioned to directly illuminate the canopy region of the one or more plants and to directly illuminate the intra-canopy volume of the one or more plants.

In accordance with another embodiment, a system can be implemented that includes a first light source capable of producing light of at least a first wavelength; a second light source capable of producing light of at least a second wavelength, wherein the second wavelength is different from the first wavelength. The first light source and the second light source are coupled to a light distribution device. A controller can cause the light distribution device to illuminate a canopy region and an intra-canopy volume with light produced from the first light source for a first period of time and to illuminate the canopy region and the intra-canopy volume with light produced from the second light source for a second period of time.

In yet another embodiment, a method can be implemented to increase biomass of one or more plants as part of a flowering/fruiting phase. The method can include illuminating a canopy and an intra-canopy volume of the one or more plants with light within the range of about 700 nm to about 760 nm, during a period after other illumination has ceased; and accelerating the conversion of phytochrome FR into phytochrome R, thus reducing the dark period required for establishing and maintaining the flowering/fruiting stage of growth of the plant(s).

This Summary is provided to introduce a selection of concepts in a simplified form that are further described below in the Detailed Description. This Summary is not intended to identify key features or essential features of the claimed subject matter nor is it intended to be used to limit the scope of the claimed subject matter. Other features, details, utilities, and aspects of the claimed subject matter will be apparent from the following more particular written Detailed Description of various embodiments as further illustrated in the accompanying drawings and defined in the appended claims.

### BRIEF DESCRIPTION OF THE DRAWINGS

FIG. 1 illustrates an example of a plant growing operation in which an intra-canopy volume is shaded by a canopy layer of leaves.

FIG. 2 illustrates an example of a light distribution system, in accordance with one embodiment.

FIG. 3 illustrates an example of a light distribution system in accordance with another embodiment.

FIG. 4 illustrates an example of a light distribution system using multi-mode fibers in accordance with yet another embodiment.

FIG. 5 illustrates a system for growing plant(s) in accordance with still another embodiment.

FIG. 6 illustrates a flow chart demonstrating a method of illuminating an intra-canopy volume in accordance with one embodiment.

FIG. 7 illustrates a flow chart demonstrating a method of illuminating an intra-canopy volume in accordance with yet another embodiment.

FIG. 8 illustrates a flow chart demonstrating a method of using multiple light sources for intra-canopy illumination in accordance with one embodiment.

FIG. 9 illustrates a flow chart demonstrating a method of promoting a flowering/fruiting phase of a plant in accordance with one embodiment.

FIG. 10 illustrates a flow chart demonstrating a method of illuminating an intra-canopy volume in accordance with one embodiment.

FIG. 11 illustrates a block diagram of a device for implementing processor based devices in accordance with one embodiment

### DETAILED DESCRIPTION

The growth and productivity of crops plants can be limited by any of several factors (or a combination thereof). Compared to the theoretical maximum growth rate of a particular plant, some of the factors that will affect growth rate include nutrient availability, moisture levels, temperature, and lighting conditions.

Lighting conditions, in particular, can be the growth-rate-limiting input either because of insufficient total illumination, or because of suboptimal light distribution. Suboptimal light distribution can occur because the system for providing illumination does not illuminate the plant(s) uniformly, e.g., by having distinctly lighter and darker areas in the light delivered to the growing area.

Suboptimal light distribution can also be seen by recognizing the self-shading problem that occurs with some plants, notably including for example crop plants such as tomatoes, some legumes, some decorative flowering plants, and Cannabis. For these plants, the leaves at the top which together form what is called a “canopy”—prevent much direct illumination from reaching the leaves below. Idealizing the plant as a central column with two or more layers of leaves arrayed in planes parallel to the ground—the canopy being the top such layer—each layer further reduces the light available to the layer(s) below it, assuming light is provided from above the plant. In instances where plant(s) are illuminated by a light source below the plant, then the first layer of leaves is considered the canopy. Note that this description of the plant serves only to facilitate the discussion that follows; the techniques described are equally applicable to plants without noticeable ranking of their leaves.

There are two primary issues with respect to leaves impacting illumination at shaded levels. First, the leaves of each layer—but especially the canopy—cover such a large percentage of the surface area at their level that only a small area remains for a direct path of light to lower leaves. Second, the light-absorbing efficiency of the leaves themselves is such that only a very small percentage of the light impinging on a leaf passes through to the level(s) below: the opacity of the leaves approaches 100% in some instances.

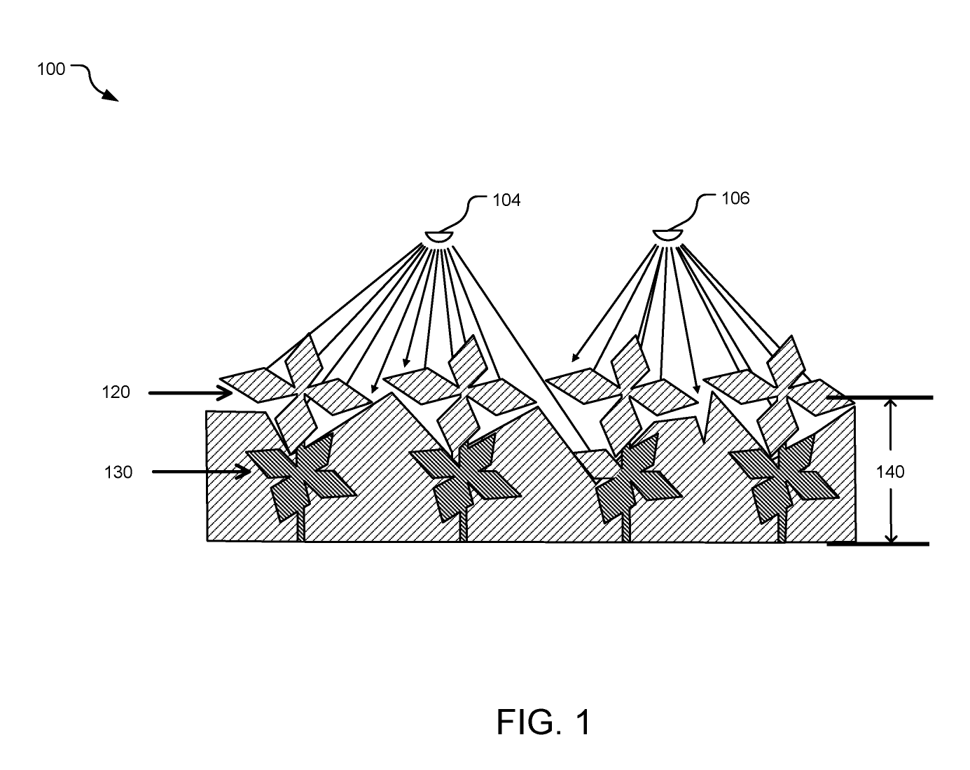

For example FIG. 1 shows an example of how illumination can be blocked by a canopy layer of leaves in a grow operation 100. In FIG. 1, a first light source 104 and a second light source 106 provide illumination to one or more plants in a grow field. A layer of leaves 120 which is closest to the light sources forms a canopy layer that blocks some of the illumination. This causes the lower regions to be shaded. These shaded regions are shown by the hatched area below the canopy region. This shaded region is referred to as the intra-canopy volume 140. A second layer of leaves 130 is shown in FIG. 1 and within the intra-canopy volume. Furthermore, it should be appreciated that there could be still further layers of leaves, as well. Moreover, the leaves do not need to be in a parallel configuration on the stalks of the plants, alternate leaf patterns could equally apply.

Because the plant produces leaves at layers below the canopy, and because the rest of the structures of the plant (stem, root system) are able to support growth in addition to the canopy layer, failing to provide sufficient light to the leaves below the canopy causes the plant to grow—that is, to increase its total biomass—more slowly than it would if those leaves below the canopy were better illuminated.

In addition to the importance of delivered illumination to the growth rate of a plant, some other characteristics of the plant's growth, including but not limited to the morphology of the plant as well as the plant's transition between life-cycle phases, can be controlled at least in part by controlling the illumination that the plant receives.

For example: the life-cycle of a crop plant can be broadly divided into two phases, described as “vegetative”, in which the plant is gaining mass through the growth of leaves, and “flowering”, which includes flowering itself, as well as the production of fruit (if any) and the rest of reproduction (e.g., the growth of seeds).

Controlling the transition between the vegetative and flowering phases is important because of the value gained by causing plants to transition quickly when they have grown to a mass where transition is desired, and because synchronizing the transition of a group of plants increases the efficiency of processing a crop.

For mediating the transition between vegetative and flowering phases, relevant elements of the illumination include the diurnal cycle of the illumination and the spectrum of the illumination. For example, by mimicking seasonal changes in solar illumination—natural illumination—these parameters of the illumination can be understood to be, in the case of some plants, signaling the plant that autumn is approaching (or has arrived), and that the plant should move into the flowering phase. Various wavelengths of light affect phytochrome compounds in the leaves of some plants which, in turn, control the plant's transition between phases.

Another example is the well-demonstrated effect of blue light on both the growth rate and morphology of plants, which varies from species to species, but generally includes a tendency toward shorter, more compact plants in the presence of sufficient blue light.

Thus, for increasing the rate of growth during the vegetative phase, for timing and accelerating the transition from vegetative to flowering phase, and for influencing plant morphology, there is value in illuminating the layers of leaves below the canopy and, in addition, having control over the spectrum of the illumination being provided.

Accepting that lighting only from above the canopy is suboptimal, one solution is to provide illumination from the sides, outside the volume circumscribed by the leaves of the plants. For a growing area that is narrow in at least one horizontal dimension, such a solution can be beneficial.

However, for a growing area that is large in both horizontal dimensions, the geometry is such that illumination from the sides will not reach the middle of the growing area; plants near the periphery of the growing area shade the plants closer to the middle. The solution is to directly illuminate the intra-canopy region from light distribution device(s) that are disposed within the intra-canopy volume.

If the source of light is a powered “bulb” of any type: incandescent bulb, fluorescent tube (or CFL), or LED lamp, then, in addition to producing light it is going to produce heat. Even for the most efficient sources—those with the highest photosynthetically-useful light production per watt consumed—the amount of heat introduced is likely to be harmful to the plant(s) illuminated.

In order to provide illumination without the undesirable heating to the intracanopy region (e.g., the volume below the canopy leaves), it is beneficial to dissociate the light and the heat. This can be done through the use of light pipes, which conduct the light from a light source located outside the intra-canopy region into that volume.

A light pipe has three general elements: a source end, which couples light into the light pipe, a light pipe proper or light pipe body, and a light delivery portion.

At the source end, the light pipe can have a source of illumination, generally either a powered light source, or light that has come from a remote source (e.g., collected solar light). Note that collected solar light, presumably arriving via another light pipe, does not have the heating problem discussed above, but still has the problem of introducing the illumination into the intra-canopy region.

The source end of the light pipe may include a jig to align the light pipe with the source, e.g., to collimate the source end with the beam being output by the source. It may also include an optical structure, e.g., a lens, to maximize and enhance conduction of the light into the light pipe. Enhancement of the light beam into the light pipe might include, for instance, focusing or defocusing the light beam in order to produce the best performance at the delivery end. These structures may be an integral part of the light pipe or components of an assembly.

If, for instance, the light pipe is implemented as a solid, rigid rod, then the source end of the rod might be polished and flat, so as to maximize transparency for light entering the rod, or it might be shaped and polished to form a curved surface to shape the entering beam. Alternatively, the light-shaping component can be independent of the rod itself, creating the assembly mentioned above.

At the delivery end, the light pipe can distribute this light into the intra-canopy region, with a goal of delivering the light to one or more leaves on one or more plants at one or more layers below the canopy. The delivery end of the light pipe may include one or more structures to enhance the delivery of the light. An enhancement could be, for instance, maximizing the uniformity of distribution of light into the target volume. These structures may be an integral part of the light pipe or components of an assembly.

Structures at the delivery end could include, for example, a half lens to spread out the light as it exits the light pipe, or other light shaping structure. In the case where the light pipe is implemented as a solid rod, the delivery end of the rod itself could be shaped to form the lens or other light shaping structure.

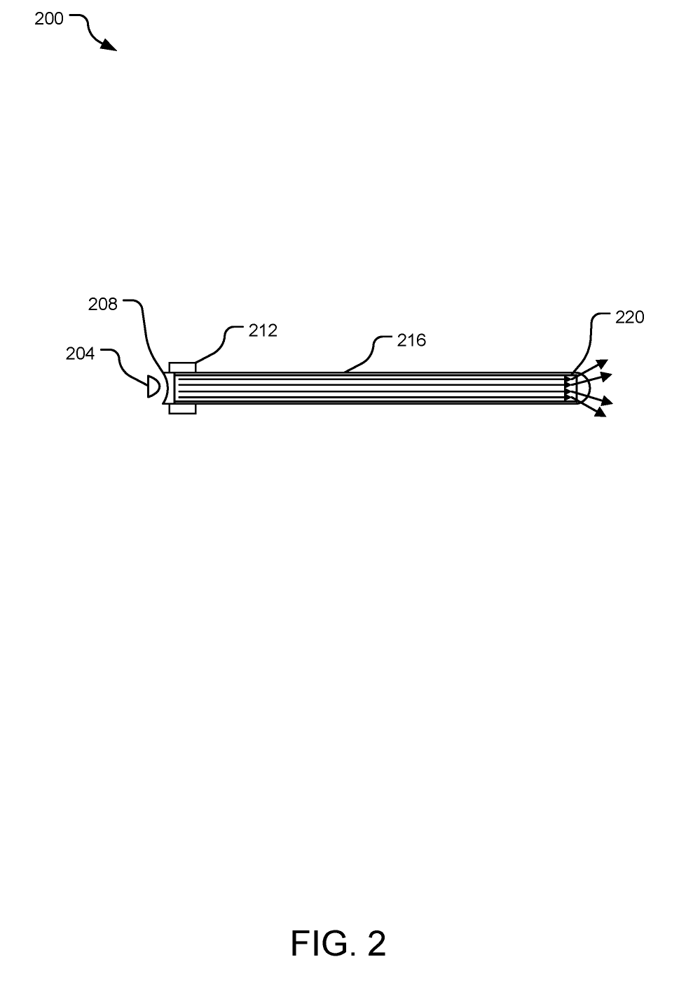

FIG. 2 shows an example of a light pipe 200 which can be used to distribute light into an intra-canopy volume. A light source 204 is shown which emits light toward a lens 208. A fitting or alignment jig can also be used to align the light source with the light pipe. The light pipe body 216 allows light to travel in the direction of the light pipe. Depending on the surface texture or treatment light can be emitted from selected portions along the light pipe body. For example, by frosting the light pipe body, light can be emitted at the frosted locations to the external environment. FIG. 2 also shows a distribution point 220. This distribution point 220 disperses light into a volume. For example, a lens or shaping of the light pipe can be used to disperse the light, as desired.

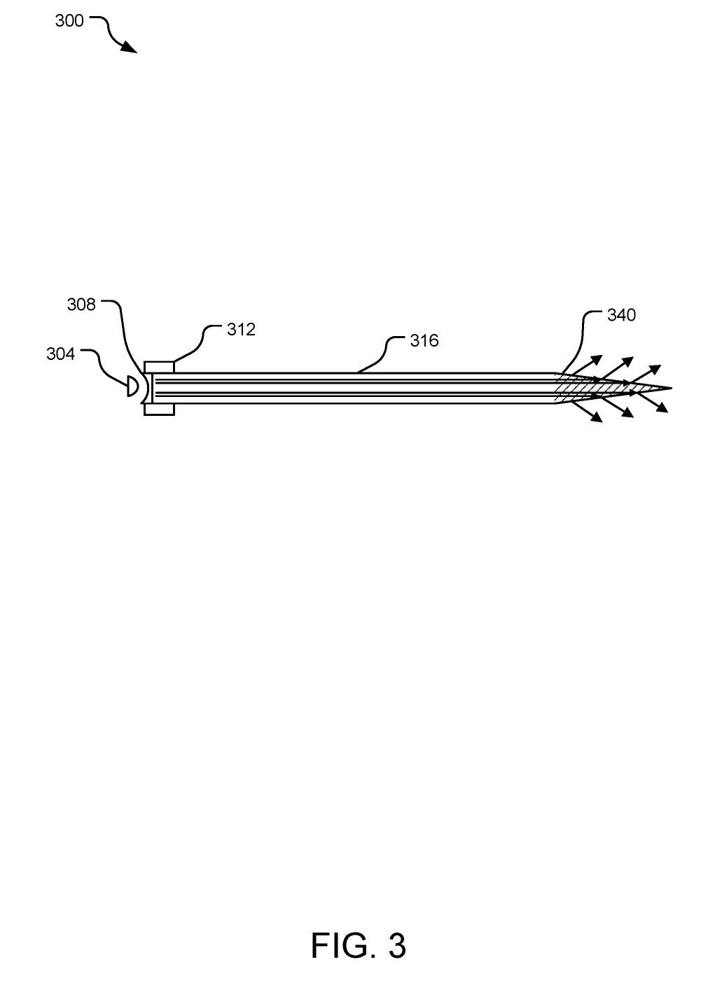

In the case where the light pipe is implemented as a solid rod, some portion of the delivery end could be frosted to cause photons to be emitted from the rod over a portion of the rod's longitudinal surface. This might include frosting alone along a length of the rod, or frosting and shaping the rod (e.g., shaping by tapering toward the delivery end) to improve the uniformity of distribution. An example of this is shown by the light pipe 300 shown in FIG. 3. In FIG. 3, a light source 304 directs light at a lens 308 which focuses light into light pipe body 316. A jig or fitting 312 is shown to align the light source and light pipe body. A tapered end 340 is used to emit light from the light pipe body. This tapered end can be frosted to facilitate light emission, e.g., by reducing total internal reflection within the light pipe body at the frosted portion. The photons are shown as being angled in multiple directions from the conical surface of the light pipe body in FIG. 3.

It should be appreciated that light in a light tube can be efficiently used by configuring light distribution points at selected portions along a light pipe. For example by locating light distribution points, such as frosted portions along a pipe, at pre-determined locations that are based on the distances between plant leaf layers, the light distribution can be efficiently tailored to a particular species of plant.

As a separate assembly, or as an integrated part of the light pipe, the source end structure may accommodate multiple light sources—e.g., multiple LED lamps—and provide a mechanism to channel the light from the sources into the light pipe, as might be useful when multiple colors or greater total power than is possible with a single source is desired.

Besides the solid light rod discussed here, one alternative light pipe would be one or more optical fibers, most likely to be multi-mode fibers. In the case where multiple optical fibers are used, distribution at the delivery end can be manipulated by separating the fibers (individually or in groups) either to have some terminate before others, to have ends of different fibers/groups pointing in different directions, or both. A component to further distribute the light coming out of the fibers, e.g. a diffuser, may also be included. For implementations which support it (e.g., optical fibers), there is no obligation for the light pipe to be straight, or rigid.

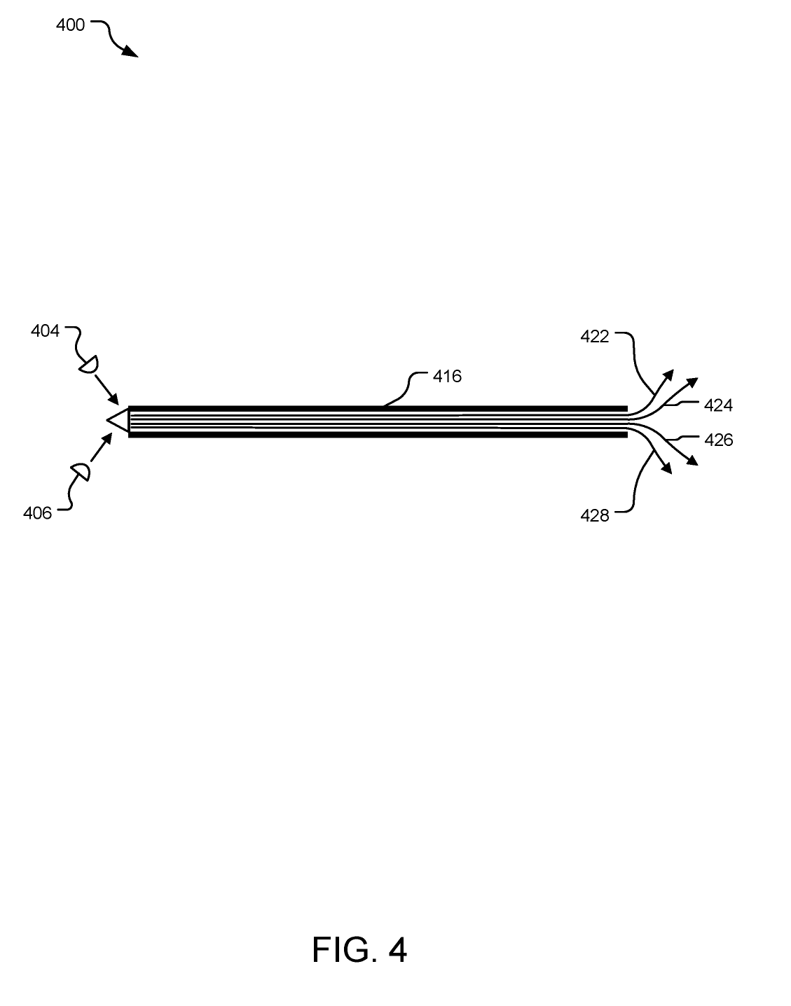

FIG. 4 illustrates an example of a multi-mode fiber light pipe. In system 400, a first light source 404 and a second light source 406 emit light. For purposes of this example, the light sources each use a predominant wavelength of light that is different from the other. The light sources can be controlled by a controller that controls when each light source is turned on and for how long. The emitted light is transmitted along the light pipe body 416. The internal portion of the light pipe body can be fashioned from a plurality of fibers so as to form a fiber bundle. These flexible fiber bundles can be configured to point in different directions. Moreover, a user can select in which direction each fiber should point. Thus, FIG. 4 shows light fibers 422, 424, 426, and 428 pointing in different directions.

In one implementation the light source is disposed above the plants and the light pipes consequently descend from above vertically or at some other angle. It is also possible to have the light source(s) below the intra-canopy volume (e.g., between the pots of potted plants or fitted into or below beds or a hydroponic system), and have the light rods ascend from below into the intra-canopy volume. In this case the light pipe assembly might be at, near, or below the root line of the plants, with the delivery end higher in the intra-canopy space and integrate the ability to redirect some or all of the light back down toward the tops of intra-canopy leaves.

Likewise, the light rods could come into the volume from the sides, with the delivery structures distributing the light according to the needs of the particular growing system.

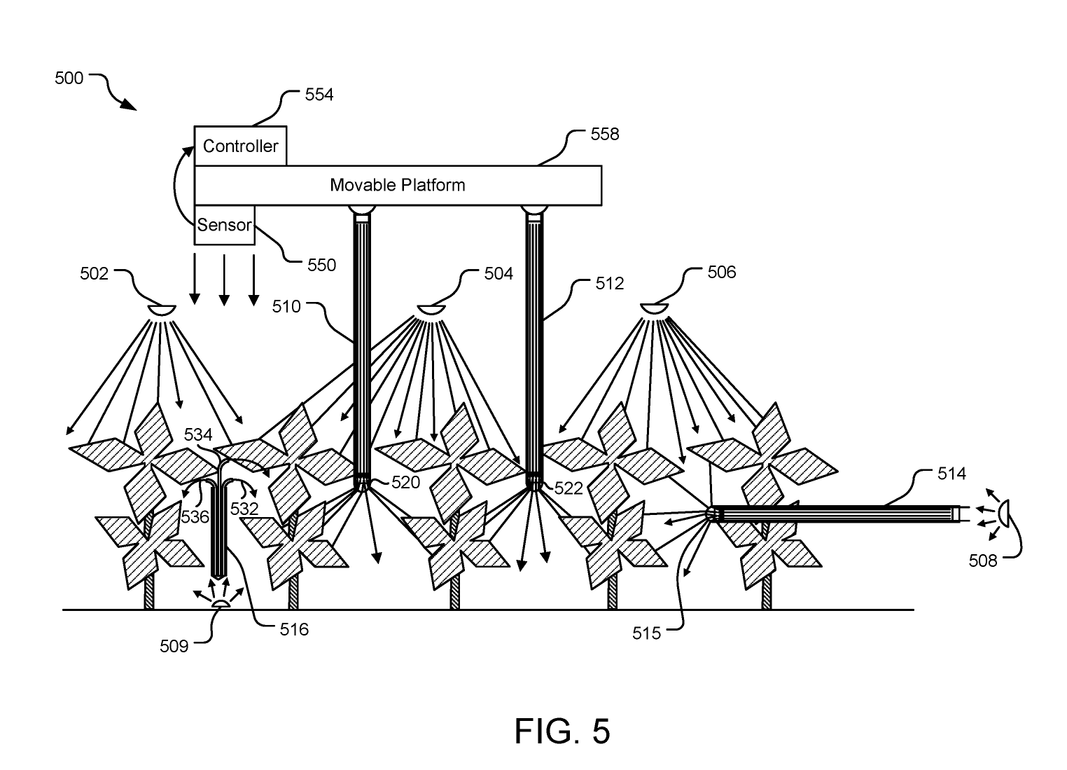

FIG. 5 illustrates an example of a system 500. In FIG. 5, light pipes are shown being inserted into the intra-canopy volume from above, below, and the side. A controller is also shown as an option to vary the position of the descending light pipes in response to a change in position of the plant(s). FIG. 5 shows light sources 502, 504 and 506 supplying light from above the plants. Descending light pipes 510 and 512 channel the light to the intra-canopy volume where the light can be further emitted to the leaves in the intra-canopy volume from distribution points 520 and 522. Similarly, light source 508 can provide light to light tube 514 which conveys light to the intra-canopy region from the side of a grow area. The light can be emitted from distribution point 515 to the intra-canopy volume. A light source 509 supplies light to a light tube 516 that ascends from beneath the plant(s). In this example of a light tube, light fibers are configurable by a user to be positioned in particular directions. Thus, light fibers 532, 534, and 536 can be oriented at specific regions of a plant(s).

The light tubes may also be coupled with a position control system. The position control system can allow the position of the light tubes to change as a plant grows. The embodiment shown in FIG. 5 shows a sensor 550, such as an ultrasonic sensor that is aimed at the top of a plant. As the plant grows, the ultrasonic sensor can detect a position of the top of the plant. This data can be supplied to a position controller 554. The position controller 554 moves movable support platform 558 so that the light tubes 510 and 512 are re-positioned in accordance with the growth of the plant(s). Alternatively, one might opt not to use the sensor in combination with the controller. Instead, a user could simply manually or automatically reposition the support structure on which the light distribution devices are attached, as the plants grow.

The system can also be designed with a less-clear distinction between the light pipe (transmission) section and the delivery components. For instance, in the case where the light pipe is implemented as a solid acrylic rod, an extended portion of the rod might be frosted to achieve maximum distribution. In the extreme case, distribution can start immediately after the introduction of light into the pipe and, in fact, can start even in the area where light is being introduced.

Likewise at the source end, the introduction of light might not be confined to a single small volume. For instance, in the case where the light pipe is implemented as a bundle of optical fibers, fibers (individually or in groups) could be spread apart and/or terminated at different lengths, e.g., to accommodate multiple light sources.

Distribution of the light transmitted by the light pipe need not be symmetric. By having structures that provide asymmetric distribution at the delivery end, the light being released can be confined to a half spherical field, for instance. This would be useful, for instance, when the light pipe is near a wall in the growing room: rather than releasing light to be absorbed by the wall, all of the light can be directed into the growing volume. A similar effect can be achieved by frosting a solid light pipe asymmetrically.

All of the aforementioned can also be applied to situations in which there is not a self-shading problem, but merely the desire to conduct concentrated light in closer proximity to the subject plants than the constraint imposed by the heat (and associated potential for damage to the plant) generated by the light source.

Multiple light sources and other components can be combined into an assembly (a “fixture” henceforth). This fixture could include some combination of the following elements:
Mechanical support for a multiplicity of light sources, ensuring correct alignment with respect to each other and the growing area below.
Light sources of different wavelengths, to provide illumination at different times and/or to different parts of the growing volume.
Light sources of multiple wavelengths (e.g., multi-color LEDs) to accomplish the same goals as discussed for different wavelengths.
Light pipes attached to some or all of the light sources as discussed above. (Light pipes might be used even for illuminating the canopy, e.g., to shape light distribution.) The light pipes may be of a variety of lengths in order to maximize their effectiveness in illuminating the target volume and/or to provide different wavelengths and/or different light cycling to different parts of the volume (e.g., at different depths).
A mechanism for conveniently moving and mounting the light pipes with different of the light sources so that the light pipes can be associated with different light sources to accommodate different growing configurations/strategies/phases.
A programmable control system allowing different lights to be turned on at different times for different durations. This system may be programmable at a low level—e.g., to turn certain bulbs on for daily/weekly/etc. cycling—or may be programmable at a higher level, e.g., to activate pre-configured “vegetative phase”, “transition phase”, etc. programs. These configurations would enhance productivity in each phase, as well as keeping plants at the same stage of development.
One or more power supplies, as necessary to convert from supply power (e.g. 110/220/440 VAC) to the power needed by the light sources and other components.
A mechanism for multiple fixtures to communicate their configuration and programming, so that their operation can be coordinated, e.g., so that the user can program the entire system by interaction with one fixture.

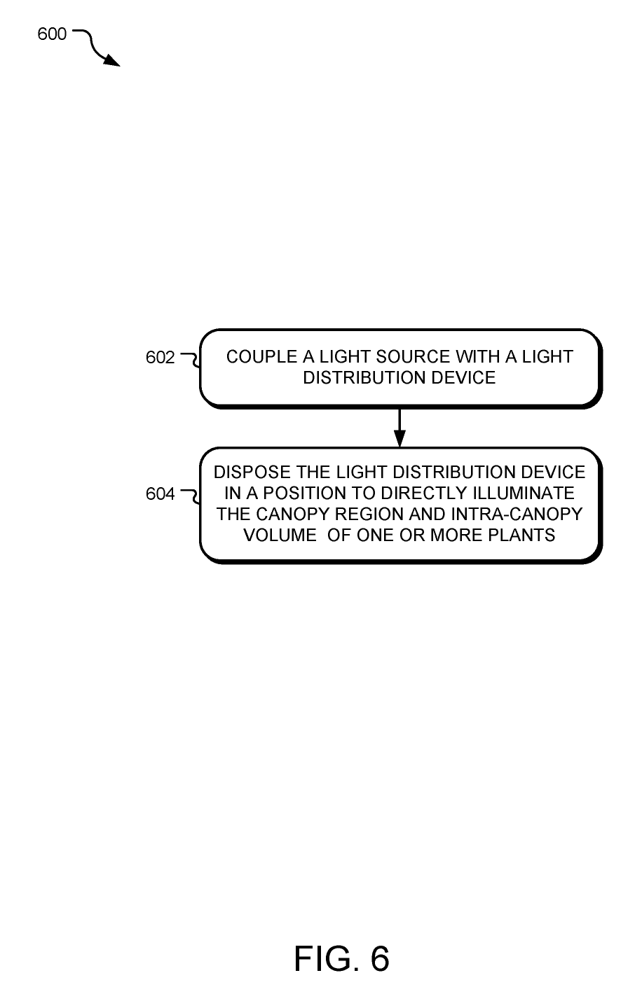

The principles described herein can also be described with reference to the following flow charts which illustrate embodiments. For example, FIG. 6 illustrates flow chart 600, which demonstrates a method of distributing light. In operation 602, a light source is coupled with a light distribution device. In operation 604, the light distribution device is disposed in a position to directly illuminate a canopy region, for example, canopy leaves, of one or more plants. The light distribution device is also disposed to illuminate an intra-canopy volume of the plant(s).

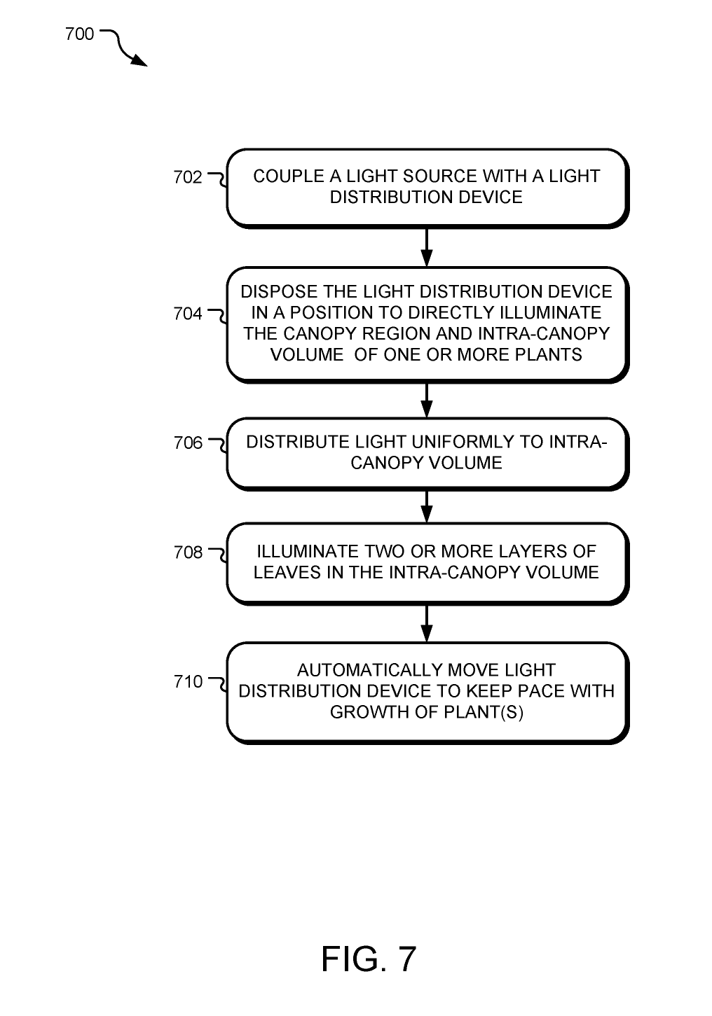

FIG. 7 illustrates a somewhat more detailed example. In operation 702, a light source is coupled with a light distribution device. The light distribution device is disposed in a position to directly illuminate a canopy region of one or more plants as well as an intra-canopy region of the one or more plants, as shown by operation 704. The light can be distributed uniformly as shown by operation 706 and can also illuminate two or more layers of leaves in the intra-canopy region as shown by operation 708. Moreover, as the plant(s) grows, the light distribution device can be moved automatically to keep pace with the growth of the plant(s) and to keep the light distribution device in a position to illuminate the intra-canopy volume, as shown by operation 710.

The light distribution device can be implemented by a light tube. The light tube can be a singular light tube or one that contains light fibers. For purposes of this document a light fiber is considered to be a light tube.

The light source can be positioned separately from the light tube so as to dissociate heat from the light tube and to substantially avoid introducing light from the light source into the intra-canopy volume.

It should be appreciated that this disclosure includes the situation where a light source(s) can be used to illuminate the canopy region of one or more plants while the same and/or a different light source(s) is used to supply light to a light tube that illuminates an intra-canopy volume of the one or more plants.

As noted above, a plurality of different light sources having different predominant wavelengths can be coupled with the light distribution device. These light sources can be used at the same time, at different times, and for different amounts of time as desired by the user. The light sources can be coupled to one or more light controllers to determine when each light source should emit light.

As noted herein, one type of light tube can use light fibers that are configurable by a user. The light fibers can be of different lengths so that some terminate above the canopy layer and others terminate within the intra-canopy volume. Moreover, the light fibers can be positioned to point in different directions. In one embodiment, a user can select the positions that the fibers should be positioned and also reconfigure the positions after an initial setting. A unitary light tube—as opposed to one made from multiple fibers—could also be fitted with light distribution points that are configurable by a user.

The light tubes can be positioned so as to be supported from above, below, or the side of a grow area. This allows the light tubes to descend into, ascend into, or cross through an intra-canopy region, respectively.

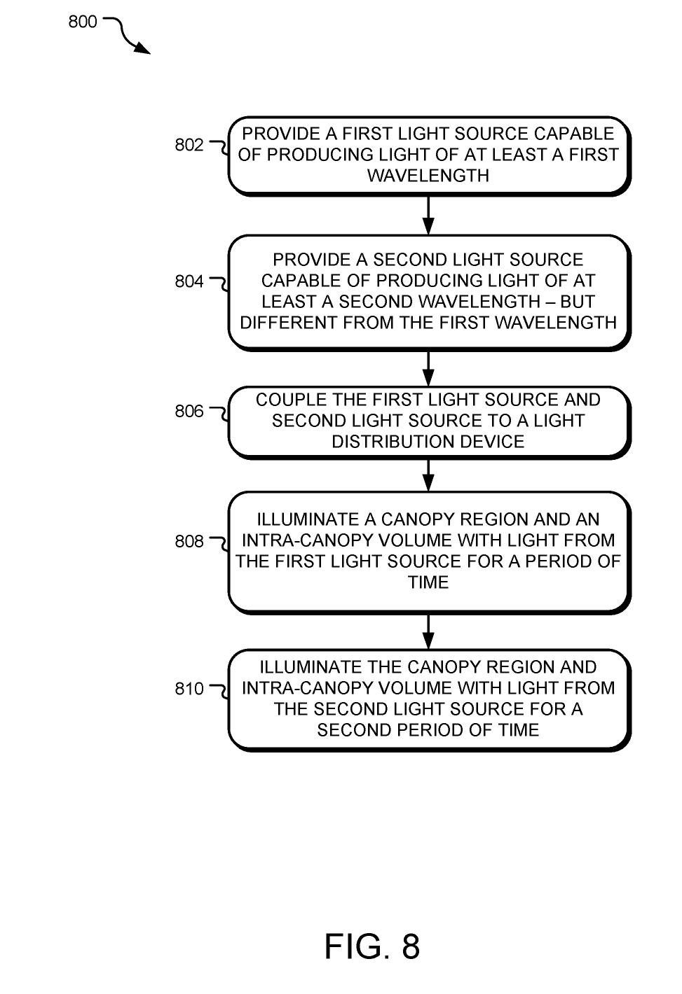

FIG. 8 is a flow chart 800 that illustrates another embodiment. In operation 802 a first light source is provided that is capable of producing light of at least a first wavelength. In operation 804, a second light source is provided that is capable of producing light of at least a second wavelength, which is different from the first wavelength. In operation 806, the first and second light sources are coupled to a light distribution device. And, in operation 808, the light distribution device is used to illuminate a canopy region and an intra-canopy volume with light from the first light source for a period of time. In operation 810, the canopy region and the intra-canopy volume can be illuminated for a second period of time. This allows two different light sources and a singular light distribution system to be used to promote growth/flowering of one or more plants, as described herein. It should be noted that the first and second light source can be part of a multi-color LED.

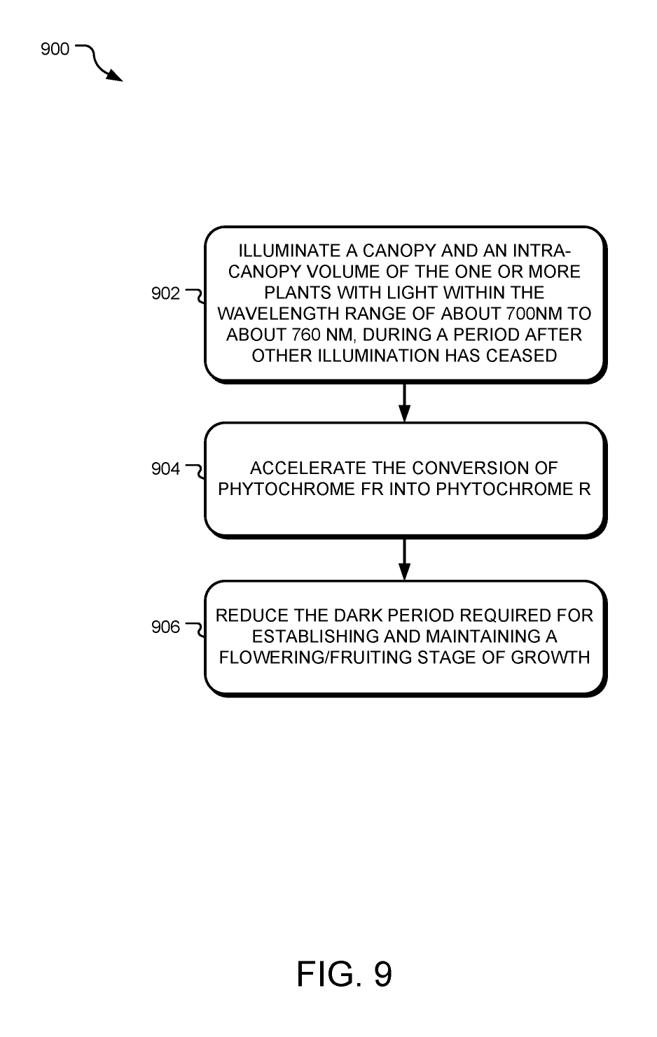

FIG. 9 illustrates another embodiment via flow chart 900. In operation 902, a canopy region and an intra-canopy volume of one or more plants are illuminated with a light from a range of about 700 nanometers to about 760 nanometers. This is preferably performed after other illumination has ceased. As explained herein, this helps to promote a transition to a flowering stage. As shown in operation 904, the use of light in this wavelength range helps to accelerate the conversion of phytochrome FR into phytochrome R. Moreover, as shown by operation 906, this is one method of reducing the dark period required for establishing and maintaining a flowering/fruiting stage of growth.

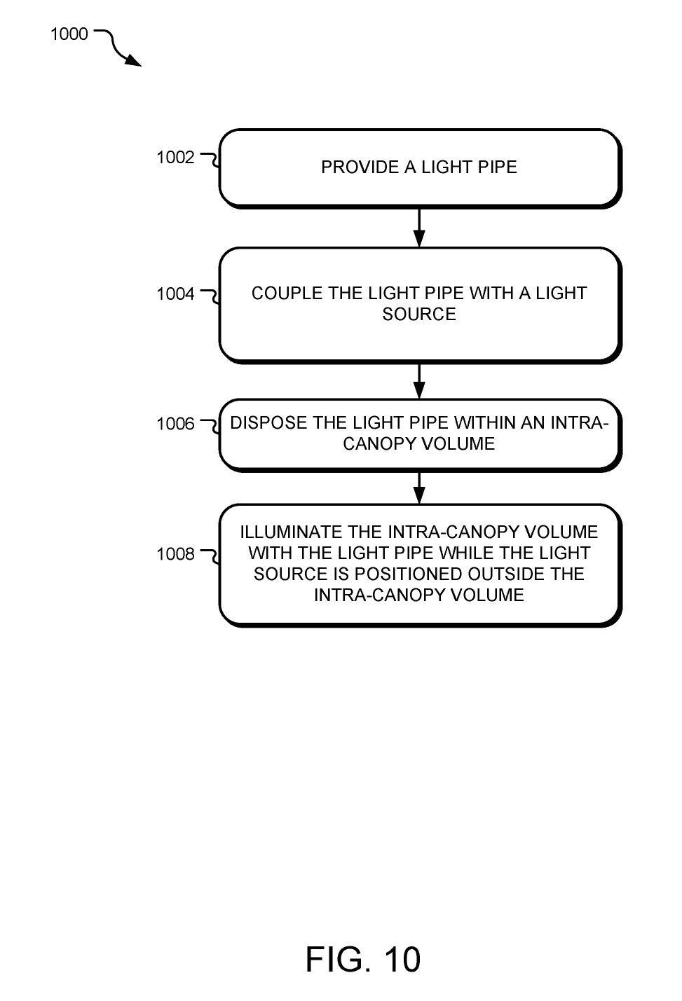

FIG. 10 illustrates a flow chart 1000. In operation 1002, a light pipe is provided. While a light pipe is used in this example, the light pipe could be replaced by a different light distribution device. In operation 1004, the light pipe is coupled with a light source. And, in operation 1006, the light pipe is disposed within an intra-canopy volume. Operation 1008 shows that the intra-canopy volume is illuminated with light from the light pipe while the light source is positioned outside of the intra-canopy volume. This embodiment solves at least a couple of problems. First, it separates heat produced by a light source from the intra-canopy volume. This allows the intra-canopy volume to be maintained at a proper temperature without the buildup of excess heat in the intra-canopy region where airflow is constrained. Moreover, it allows the intra-canopy region to be illuminated directly. As noted herein, illumination of plants that have large canopies present a unique problem not previously resolved. While ambient light in nature might be capable of growing plants in nature, it does not necessarily suffice for commercial operations where large canopy plants are grown together and sometimes in tight quarters. The resulting canopy in such grow operations creates a substantial barrier to light by the canopies of the plants. Thus, the methods described herein permit the illumination of the intra-canopy volume via direct illumination. The system described in FIG. 10 could similarly include the other design aspects of the other embodiments described herein.

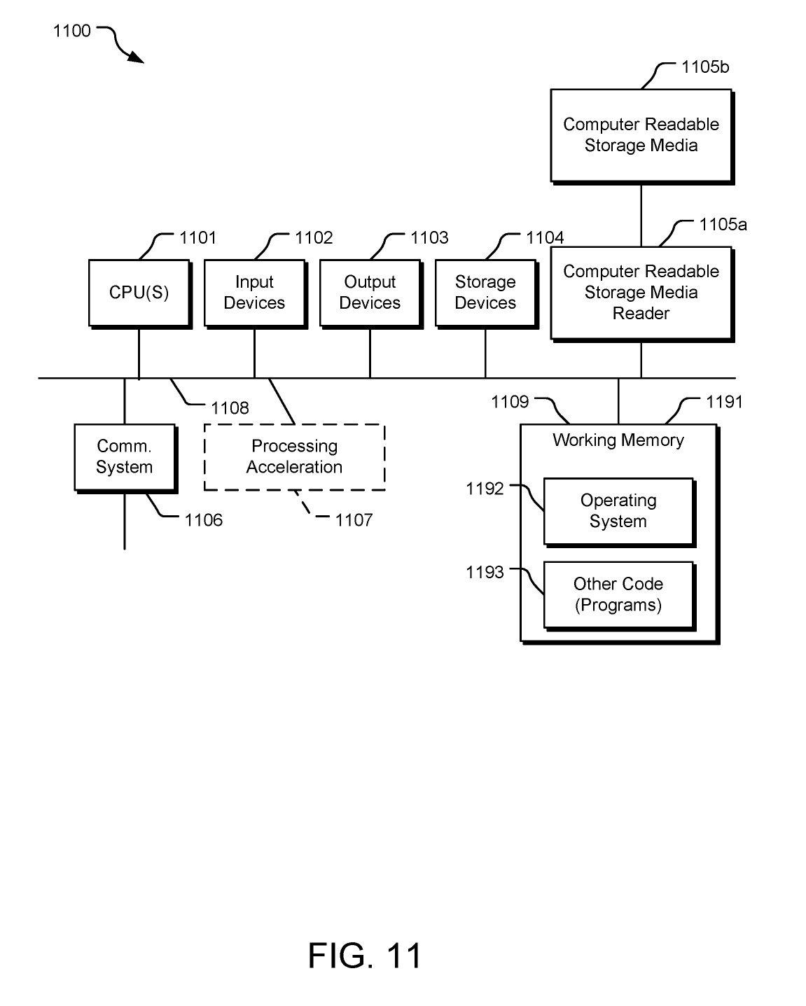

FIG. 11 illustrates an example of a system that can be utilized for implementing automated light distribution systems in accordance with some embodiments. FIG. 11 broadly illustrates how individual system elements, such as the controller system 550, 554, 558, can be implemented. System 1100 is shown comprised of hardware elements that are electrically coupled via bus 1108, including a processor 1101, input device 1102, output device 1103, storage device 1104, computer-readable storage media reader 1105a, communications system 1106 processing acceleration (e.g., DSP or special-purpose processors) 1107 and memory 1109. Computer-readable storage media reader 1105a is further coupled to computer-readable storage media 1105b, the combination comprehensively representing remote, local, fixed and/or removable storage devices plus storage media, memory, etc. for temporarily and/or more permanently containing computer-readable information, which can include storage device 1104, memory 1109 and/or any other such accessible system 1100 resource. System 1100 also comprises software elements (shown as being currently located within working memory 1191) including an operating system 1192 and other code 1193, such as programs, applets, data and the like. As used herein, the term ‘processor’ includes any of one or more circuits, processors, controllers, filed-programmable gate arrays (FPGAs), microprocessors, application-specific integrated circuits (ASICs), other types of computational devices, or combinations thereof that are capable of performing functions ascribed to or associated with the processor.

System 1100 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 1100 component (e.g. within communications system 1106). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 1100 components will necessarily be required in all cases.

It should be appreciated that the light distribution devices described herein can be used with a light source(s) to illuminate the intra-canopy volume of one or more plants. In such an instance the canopy region of the plant(s) can be illuminated by the same and/or a different light source(s).

While various embodiments have been described as methods or apparatuses, it should be understood that embodiments can be implemented through code coupled with a computer, e.g., code resident on a computer or accessible by the computer. For example, software and databases could be utilized to implement many of the methods discussed above. Thus, in addition to embodiments accomplished by hardware, it is also noted that these embodiments can be accomplished through the use of an article of manufacture comprised of a non-transitory computer usable medium having a computer readable program code embodied therein, which causes the enablement of the functions disclosed in this description. Therefore, it is desired that embodiments also be considered protected by this patent in their program code as well. Furthermore, the embodiments may be embodied as code stored in a computer-readable memory of virtually any kind including, without limitation, RAM, ROM, magnetic media, optical media, or magneto-optical media. Even more generally, the embodiments could be implemented in software, or in hardware, or any combination thereof including, but not limited to, software running on a general purpose processor, microcode, PLAs, or ASICs.

The light distribution system described herein can be utilized in association with other light distribution systems. For example, features of the present system can be utilized with features of the system taught in U.S. Pat. No. 8,955,249 entitled “Light Rod for Accelerating Algae Growth,” which is hereby incorporated by reference in its entirety and for all purposes.

It is also noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

It will be understood that while embodiments have been described in conjunction with specific examples, the foregoing description and examples are intended to illustrate, but not limit the scope of the disclosed technology. The elements and use of the above-described embodiments can be rearranged and combined in manners other than specifically described above, with any and all permutations within the scope of the disclosure.

What is claimed is:

1. A method of growing one or more plants wherein the one or more plants establish a canopy that shades an intra-canopy volume of the one or more plants from direct illumination, the method comprising:
coupling a light source with a light distribution device;
disposing the light distribution device in a position to directly illuminate the canopy region of the one or more plants and to directly illuminate the intra-canopy volume of the one or more plants.

2. The method of claim 1 wherein coupling the light source with a light distribution device comprises:
utilizing a light pipe as the light distribution device.

3. The method of claim 1 wherein coupling the light source with a light distribution device comprises:
utilizing a plurality of optical fibers as the light distribution device.

4. The method of claim 1 wherein heat from the light source is not introduced to the intra-canopy volume of the one or more plants due to the direct illumination of the intra-canopy volume of the one or more plants.

5. The method of claim 1 wherein coupling the light source with the light distribution device substantially dissociates any heat from the light source and the light emitted by the light source so that the heat from the light source is substantially not introduced into an intra-canopy volume of the one or more plants.

6. The method of claim 1 wherein the light distribution device is configured to provide substantially uniform light distribution to the intra-canopy volume of the one or more plants.

7. The method of claim 1 wherein the light distribution device is configured to illuminate two or more layers of leaves of a particular plant in the intra-canopy volume of the one or more plants.

8. The method of claim 1 wherein the coupling the light source with the light distribution device comprises:
coupling a plurality of different light sources of different wavelengths with the light distribution device.

9. The method of claim 3 and further comprising:
utilizing optical fibers of different lengths so that some fibers will terminate above the canopy and other fibers will terminate in the intra-canopy volume.

10. The method of claim 2 wherein at least two portions of the light pipe are configured to point in different directions.

11. The method of claim 2 wherein at least one portion of the light pipe can be oriented by the user to point in a user-selected direction.

12. The method of claim 3 wherein different optical fibers are disposed to point in different directions.

13. The method of claim 3 wherein at least one of the optical fibers can be oriented by the user to point in a user-selected direction.

14. The method of claim 1 wherein the light distribution device is supported from above the one or more plants and extends downward into the intra-canopy volume.

15. The method of claim 1 wherein the light distribution device is supported from below the one or more plants and extends upward into the intra-canopy volume.

16. The method of claim 1 wherein the light distribution device extends sideways through the intra-canopy volume and across a plurality of plant stalks.

17. The method of claim 1 wherein the light distribution device distributes light in an asymmetric pattern.

18. The method of claim 1 and further comprising:
positioning the light distribution device in a corner region of a grow area and distributing light asymmetrically from the light distribution device in the intra-canopy volume.

19. The method of claim 1 and further comprising:
automatically moving the light distribution device to keep pace with a change in position of the canopy or intra-canopy volume during growth of the one or more plants.

20. A method comprising:
providing a first light source capable of producing light of at least a first wavelength;
providing a second light source capable of producing light of at least a second wavelength, wherein the second wavelength is different from the first wavelength;
coupling the first light source and the second light source to a light distribution device;
illuminating a canopy region and an intra-canopy volume with light produced from the first light source for a first period of time;
illuminating the canopy region and the intra-canopy volume with light produced from the second light source for a second period of time.

21. The method of claim 20 wherein the first light source and the second light source are part of a multi-color LED.

22. A system for growing one or more plants wherein the one or more plants establish a canopy that shades an intra-canopy volume of the one or more plants from direct illumination, the system comprising:
a light distribution device;
a light source coupled with the light distribution device;
wherein the light distribution device is positioned to directly illuminate the canopy region of the one or more plants and to directly illuminate the intra-canopy volume of the one or more plants.

23. The system of claim 22 wherein the light distribution device comprises a light pipe.

24. The system of claim 22 wherein the light distribution device comprises a plurality of optical fibers.

25. The system of claim 22 wherein the coupling of the light source with the light distribution device inhibits heat from being introduced to the intra-canopy volume of the one or more plants.

26. The system of claim 22 wherein coupling the light source with the light distribution device substantially dissociates any heat from the light source and the light emitted by the light source so that the heat from the light source is substantially not introduced into an intra-canopy volume of the one or more plants.

27. The system of claim 22 wherein the light distribution device is configured to provide substantially uniform light distribution to the intra-canopy volume of the one or more plants.

28. The system of claim 22 wherein the light distribution device is configured to illuminate two or more layers of leaves of a particular plant in the intra-canopy volume of the one or more plants.

29. The system of claim 22 wherein the coupling of the light source with the light distribution device comprises:
a plurality of different light sources of different wavelengths coupled with the light distribution device.

30. The system of claim 24 and further comprising:
wherein some of the optical fibers terminate above the canopy and other fibers terminate in the intra-canopy volume.

31. The system of claim 23 wherein at least two portions of the light pipe are configured to point in different directions.

32. The system of claim 23 wherein at least one portion of the light pipe can be oriented by the user to point in a user-selected direction.

33. The system of claim 24 wherein different optical fibers are disposed to point in different directions.

34. The system of claim 24 wherein at least one of the optical fibers can be oriented by the user to point in a user-selected direction.

35. The system of claim 22 wherein the light distribution device is supported from above the one or more plants and extends downward into the intra-canopy volume.

36. The system of claim 22 wherein the light distribution device is supported from below the one or more plants and extends upward into the intra-canopy volume.

37. The system of claim 22 wherein the light distribution device extends sideways through the intra-canopy volume and across a plurality of plant stalks.

38. The system of claim 22 wherein the light distribution device distributes light in an asymmetric pattern.

39. The system of claim 22 wherein the light distribution device is disposed in a corner region of a grow area and configured to distribute light asymmetrically from in the intra-canopy volume.

40. The system of claim 22 and further comprising:
an automated positioner configured to move the light distribution device to keep pace with a change in position of the canopy or the intra-canopy volume during growth of the one or more plants.

41. A system comprising:
a first light source capable of producing light of at least a first wavelength;
a second light source capable of producing light of at least a second wavelength, wherein the second wavelength is different from the first wavelength;
the first light source and the second light source coupled to a light distribution device;
a controller to cause the light distribution device to:
illuminate a canopy region and an intra-canopy volume with light produced from the first light source for a first period of time;
illuminate the canopy region and the intra-canopy volume with light produced from the second light source for a second period of time.

42. The system of claim 41 wherein the first light source and the second light source are part of a multi-color LED.

43. A method of increasing biomass of one or more plants as part of a flowering/fruiting phase, comprising:
illuminating a canopy and an intracanopy volume of the one or more plants with light within the range of 700 to 760 nm, during a period after other illumination has ceased;
accelerating the conversion of phytochrome FR into phytochrome R, thus reducing the dark period required for establishing and maintaining the flower/fruiting stage of growth.

44. A method of growing one or more plants wherein the one or more plants establish a canopy that shades an intra-canopy volume of the one or more plants from direct illumination, the method comprising:
providing a light pipe;
coupling the light pipe with a light source;
disposing the light pipe within an intra-canopy volume; and
illuminating the intra-canopy volume with the light pipe while the source is positioned outside the intra-canopy volume.

45. A system for growing one or more plants wherein the one or more plants establish a canopy that shades an intra-canopy volume of the one or more plants from direct illumination, the system comprising:
a light pipe;
a light source coupled with the light pipe;
wherein the light pipe is positioned to directly illuminate the intra-canopy volume of the one or more plants while the light source is positioned outside of the intra-canopy volume.
